(19) United States
(12) Patent Application Publication
(10) Pub. No.: US 2015/0088727 A1
(43) Pub. Date: Mar. 26, 2015

(54) METHOD FOR DETERMINING CREDITWORTHINESS FOR EXCHANGE OF A PROJECTED, FUTURE ASSET

(71) Applicant: C2FO, Fairway, KS (US)

(72) Inventor: Scott Goldblatt, Overland Park, KS (US)

(73) Assignee: C2FO, Fairway, KS (US)

(21) Appl. No.: 14/035,442

(22) Filed: Sep. 24, 2013

(51) Int. Cl. G06Q 40/02

(52) U.S. Cl. CPC G06Q 40/025
USPC 705/38

(57) ABSTRACT

Methods and systems for extending credit to a business borrower and, more specifically, methods and systems for estimating future receivables for the borrower based on historical business data and exchanging the estimated future receivables for an early payment and, more preferably, for an early payment by a customer of the borrower.

### CROSS-REFERENCE TO RELATED APPLICATIONS

Not Applicable

### TECHNICAL FIELD

The invention relates to methods and systems for extending credit to a business borrower and, more specifically, to methods and systems for estimating future receivables for the borrower and, subsequently, exchanging the estimated future receivables for some consideration.

### BACKGROUND OF THE INVENTION

In the course of operation, businesses are constantly seeking financing such as loans to provide needed working capital on a short-term or a long-term basis. Such financing involves lending institutions that typically view the transaction as a current payment of monetary funds, e.g., the principal, to the business borrower for a future re-payment of the original principal plus further consideration, e.g., a fee or interest.

Often times, depending on the amount, and duration of the loan, these transactions may require collateralization of some of the borrower's assets, such as real or intellectual property, personalty, and the like. Conventional credit scores and credit ratings of the business borrower, which look backwards at the borrower's historical performance (or non-performance) can affect the consideration required by the lender to issue the loan.

These conventional metrics only consider current or historical assets or practices. They may incorrectly gauge the risk associated with a loan to a business borrower that, e.g., will immediately or in the near future realize a significant asset that could be used to satisfy a loan that is issued today.

Accordingly, it would be desirable to provide a method of evaluating a business borrower's creditworthiness to enable the business borrower to receive payment for a future asset, e.g., a projected account receivable. Such a method may be adapted to look not only backward at the borrower's historical business data, e.g., accounts receivable history, but also to look forward at future, projected business, e.g., goods, products, services, and the like. Indeed, it would be particularly advantageous to provide a method for scoring the borrower's creditworthiness as well as for determining an appropriate value for a business borrower's projected future assets.

### SUMMARY OF THE INVENTION

In a first aspect of the present invention, a method for extending credit to a borrower is disclosed. In some embodiments, the method comprises estimating future receivables for the borrower and, subsequently, exchanging the estimated future receivables for a payment, e.g., a payment made by a customer of the borrower, or other suitable consideration. In some variations, estimating future receivables may comprise estimating a likelihood of the issuance of a future invoice by the borrower. In other variations, estimating future receivables may comprise estimating a value of a future predicted invoice. In still other variations, estimating future receivables may comprise estimating a temporal range for a future predicted invoice. For example, estimating the future receivable may include any of: identifying customers previously contracted with by the borrower; identifying a frequency, amount, and total number of invoices in the aggregate for customers of the borrower; identifying a frequency, amount, and total number of invoices for a specific customer of the borrower; evaluating industry-wide invoice loading for the borrower's industry; evaluating industry-wide discounting, bidding, and frequency of invoices for the borrower's industry; evaluating industry-wide invoice loading for a customer's industry; and evaluating industry-wide discounting, bidding, and frequency of invoices for a customer's industry.

In other embodiments, the estimate is made using data concerning the historical business between the borrower and one or more of the borrower's customers and the payment made discounts the amount of the estimated future receivables.

In yet other embodiments, the method further comprises the development of a creditworthiness score for the borrower based on the estimated future receivables. For example, developing the creditworthiness score may include providing a numerical score using historical business information for at least one of: the nature of the business partnership between the borrower and the customer or some other third party not previously having a business partnership with the borrower, the frequency of awards to the borrower, the average amount of such awards, the range of award amounts, the temporal frequency of bidding between the borrower and a customer or some other third party not previously having a business partnership with the borrower, an average discount amount associated with the award to the borrower, the range of discounts associated with awards in the aggregate, the temporal frequency of discounting, and so forth.

In a second aspect, the present invention discloses a system for extending credit to a borrower wherein the credit is provided by a customer of the borrower. In some embodiments, the system may comprises a memory containing borrower's historical business data, e.g., transactions between the borrower and any of the plurality of customers, and a processing device that is structured and arranged to process the historical business data from the memory and to estimate a future receivable, e.g., using the historical business transaction data, for any of a plurality of customers, which estimate may be stored in a suitable database in the memory. For example, estimating the future receivable may include processing historical data stored in memory to accomplish any of: identifying customers of the borrower; identifying a frequency, amount, and total number of invoices in the aggregate for all customers of the borrower; identifying a frequency, amount, and total number of invoices for a specific customer of the borrower; evaluating industry-wide invoice loading for the borrower's industry; evaluating industry-wide discounting, bidding, and frequency of invoices for the borrower's industry; evaluating industry-wide invoice loading for a customer's industry; and evaluating industry-wide discounting, bidding, and frequency of invoices for a customer's industry.

In some variations of the present invention, the processing devices may be structured and arranged to develop a creditworthiness score for the borrower based on the estimated future receivables, which score may be stored in a suitable database in the memory. In other variations, the processing device may be adapted to estimate a likelihood of a future invoice for the borrower. In still other variations, the processing device may be adapted to estimate a value of a future predicted invoice in estimating future receivables and/or to estimate a temporal range for a future predicted invoice in estimating future receivables. In further variations, the processing device may be adapted to exchange the estimated future receivable for a payment.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 shows a diagram of an exemplary flow chart of an embodiment of a method for predicting the likelihood of a future asset for use in scoring the creditworthiness of a business borrower intent on exchanging a predicted, future asset for some consideration.

FIG. 2 shows a block diagram of an exemplary embodiment of a system for predicting the likelihood of a future asset for use in scoring the creditworthiness of a business borrower intent on exchanging a predicted, future asset for some consideration.

### DETAILED DESCRIPTION OF THE INVENTION

A method of extending credit to a borrower is disclosed. The method supplants conventional, risk-based approaches to generating capital, e.g., from loans, that may require repeated, frequent collateralization of business assets. In short, instead of collateralizing existing business assets, according to the present method, assets to be realized, such as accounts receivable that have not yet been incurred, are collateralized.

In one embodiment, the method may include evaluating, e.g., scoring, a business borrower's creditworthiness to enable the business borrower to receive some current consideration in exchange for a future asset, e.g., a projected account receivable. This typically includes predicting the probability of the realization of the future asset, e.g., a projected account receivable, and attributing some numerical value to that probability. Although the method will be described primarily in an externally-applied context, which is to say, in a context for which the business borrower endeavors to receive some consideration, the method is equally applicable to an internal context, e.g., to provide internal measurements and planning for purposes such as marketing, predictive attrition, and the like.

According to the present invention, the method relies in part on historical business data of the business borrower, potentially including data describing relationships between the business borrower and its customers, further taking into account established or extracted industry-wide norms and practices, as well as other factors. Although the invention will be described using exemplary data involving a business borrower and its customer, the invention is not to be construed as being limited to or otherwise requiring data describing a relationship between a borrower and a customer of the borrower. Indeed, for the purpose of acquiring some current consideration in return for a projected, future asset, the borrower may effect the exchange with any one or several of the borrower's customers or with various third parties with whom the business borrower may have no prior relationship. Moreover, the prediction and scoring may take into account specific customers of the borrower or may take into account the borrower's customers in the aggregate.

With these historical business data, a processing device may be structured and arranged to determine or to calculate a credit or creditworthiness score that is predicated, at least in part, on the probability of the creation of a projected asset, e.g., an account receivable, at some pre-designated or estimated time in the future. The scoring may use data on a discrete customer of the borrower for a one-to-one exchange or may extend to the borrower's customers in the aggregate for a third party exchange. Hence, predictability may be based on data for a single customer or on data for a plurality of customers.

“Historical business data” is to be given its broadest interpretation and should not be construed as being limited to the information mentioned and/or described herein. For example, “historical business data” may include the borrower's invoice history for goods and/or services, e.g., accounts receivable, in the aggregate as well as for individual customers; the borrower's bidding history; the borrower's award, i.e., early payment, history; and so forth.

“Bidding” implies that instead of offering the projected, future asset to the predicted recipient customer, the projected asset may be offered in an auction or open bidding scenario in which the projected future asset is awarded to the highest bidder. The bidding and award histories may include, for example, one or more of the following: the nature of the business partnership between the borrower and the bidder, the frequency of awards to the borrower, the average amount of such awards, the range of award amounts, the temporal frequency of bidding between the borrower and a customer or some other third party not previously having a business partnership with the borrower, an average discount amount associated with the award to the borrower, the range of discounts associated with awards in the aggregate, the temporal frequency of discounting, and so forth. Preferably, the method as well as a system structured and arranged to execute the method are adapted to process these data, some subset of these data, or these data plus other relevant data, e.g., external, publicly-available data, industry-related bidding amount, range, and frequency norms, industry-related award amount and range norms, industry-related discounting norms, and the like, to derive a numerical score. Advantageously, industry-related norms can include the borrower's industry as well other industry data.

In turn, the creditworthiness score may be used by one or more of the borrower's customers or by one or more third parties to evaluate the financial advantage of providing or awarding the borrower with a pre-payment in exchange for a future payoff based on predicted assets, i.e., a future invoice or accounts receivable, which is to say accounts receivable that may not be incurred, or may be under contract but that are not currently scheduled for payment, that have not been approved for payment, and/or that have not be transmitted for payment. When the purchaser of the predicted asset agrees to pre-payment in exchange for the predicted asset, both the purchaser and the seller benefit. For example, at the time of the exchange, the seller receives an inflow of working capital without the collateralization required by a conventional lender. At some future date, the purchaser may receive compensation for the purchased asset, potentially realizing a profit on an asset that was purchased at a discount to its expected value.

Thus, the bidder may determine if she wants to provide a pre-payment to a borrower based upon the probabilities and scoring of the likelihood of the realization of a future asset such as accounts receivable; and, second, the amount of the pre-payment. Those of ordinary skill in the art can appreciate that, although, this description of the invention has assumed at points that the bidder has a pre-existing relationship with the seller, the invention is not to be construed as being limited simply to that scenario. More particularly, a request for some current consideration in exchange for predicted assets may also be posted, e.g., via a network such as the World Wide Web, the Internet, an intranet, a wide area network, a local area network, and the like, for third parties to actively bid on. Third parties may bid on a single predicted asset or, in the alternative, a plurality of future assets may be organized, e.g., into a tranche, that can be put up for bid. At some future date, the third party would be compensated for the predicted assets.

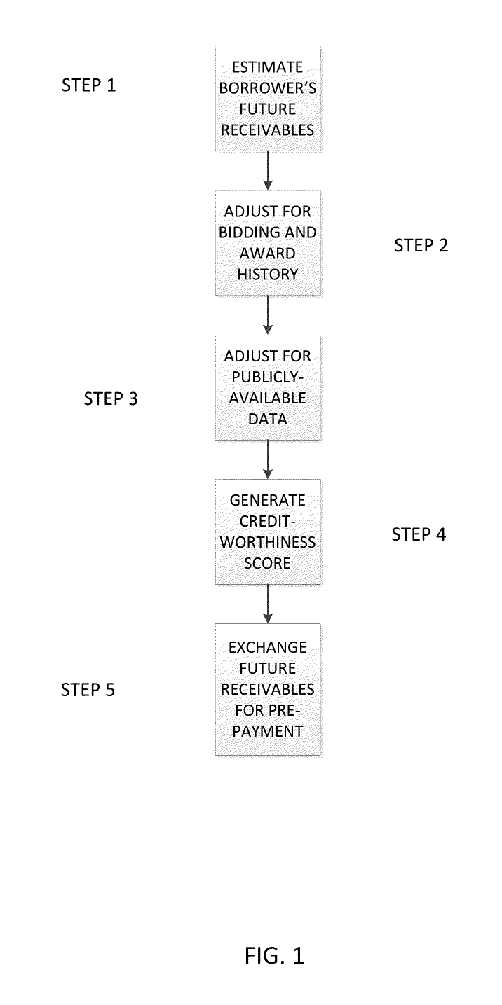

Referring to FIG. 1, an exemplary flow chart illustrating an embodiment of a method of evaluating, e.g., scoring, a business borrower's creditworthiness, which is designed to enable the business borrower to receive some current consideration in exchange for a predicted, future asset, is shown. In its simplest terms the method extends credit to a borrower without requiring collateralization of known assets, allowing for instead, collateralization of predicted, future assets, e.g., an account receivable. Initially, an estimation or prediction of future assets, e.g., accounts receivable, of the borrower may be made (STEP 1). Estimating future receivables may comprise estimating a likelihood of a future invoice for the borrower; estimating a value of a future predicted invoice; and/or estimating a temporal range for occurrence of the future predicted invoice. The estimation may be made using a processing device that is capable of executing instructions, e.g., a software application, an algorithm, and the like, to process historical business data that may be stored in a database in a memory. As previously provided, the estimation may be based on historical business data for a specific customer or for a borrower's customers in the aggregate. In large part, these data include the borrower's historical invoices, e.g., accounts receivable, information as to amounts billed to a discrete customer in the past, temporal or seasonal frequencies of such amounts, and so forth.

In estimating future assets of the borrower, the method may include identifying customers of the borrower; identifying a frequency, amount, and total number of invoices in the aggregate for all customers of the borrower; identifying a frequency, amount, and total number of invoices for a specific customer of the borrower; evaluating industry-wide invoice loading for the borrower's industry; evaluating industry-wide discounting, bidding, and frequency of invoices for the borrower's industry; evaluating industry-wide invoice loading for each customer's industry; and evaluating industry-wide discounting, bidding, and frequency of invoices for each customer's industry. For example, from the estimation (STEP 1), it may be determined that the business borrower may expect in six weeks future invoices for goods, products, and/or services in amounts X_{A}, X_{B}, and X_{C} for customer A, customer B, and customer C, respectively.

Once the estimation has been completed (STEP 1) or as part of the estimation, the predicted asset amounts X_{A}, X_{B}, and X_{C} may be adjusted to account for the particular borrower's bidding and award history (STEP 2). Adjustment may be upwards or downwards using factors concerning the borrower as well as either or both of the borrower's and the customer's industry. For example, the nature of these bidding and award history adjustments may include, for example, the nature of the business relationship between the borrower and the customer or bidder, the frequency of awards, i.e., early payments, to the borrower, the average amount of such awards, the range of award amounts, the temporal frequency of bidding, an average discount amount associated with all awards to the borrower, the range of discounts associated with all awards, the temporal frequency of discounting, and so forth. For example, nature of business relationship adjustments may take into account whether or not the raw, predicted, future asset amounts X_{A}, X_{B}, and X_{C} are to be dealt with, i.e., collateralized, individually or are to be collected into a single, predicted, future asset X_{T} or whether an offer for an exchange is made to the respective customers A, B, and C or to a third party. It is this expectation of a future asset, which is predicted to occur within the next six weeks, coupled with the borrower's bidding and award history that allows the predicted accounts receivable for customer A, customer B, and customer C to be collateralized.

Optionally, once the estimation has been completed (STEP 1) or as part of the estimation, the raw, predicted, future asset amounts X_{A}, X_{B}, and X_{C} may also be adjusted to account for other relevant data, e.g., external, publicly-available data, industry-related bidding amount, range, and frequency norms, industry-related award amount and range norms, industry-related discounting norms, and the like (STEP 3). This optional step adjusts the score to account for factors that are related to the borrower's business as well as to the borrower's industry generally. Relevant, external, publicly-available data may include public credit scores, SEC filing information, BBB ratings, Dun & Bradstreet ratings, earnings reports, stock prices, shareholder reports, and the like. Advantageously, industry-related norms can include the borrower's industry as well as the purchaser's industry. Such data may be available from a number of sources, many or most of which may be made available through the Internet or some other network. Accordingly, the processing device may include a browser and browsing software to enable it to seek such publicly-available information.

Having adjusted the estimation to account for the borrower's bidding and award history (STEP 2) and, optionally, to account for external, publicly-available data (STEP 3), the processing device may be adapted to generate a creditworthiness score (STEP 4), e.g., a numerical score, which customers or third parties may use to evaluate whether or not to exchange some consideration, e.g., a pre-payment, for a predicted, future asset (STEP 5). Although generating a creditworthiness score may use all or some sub-set of the same data previously used in the estimation step, “scoring” may include an evaluation of the borrower's track record in previous exchanges. For example, developing a creditworthiness score may include providing a numerical score that takes into account historical business information such as the borrower's average consideration received, the borrower's range of consideration received, the borrower's average discount, the borrower's discount range, a temporal frequency of discounts, a temporal frequency of bidding, a temporal frequency of an early payment award to the borrower, an average amount of the early payment award to the borrower, and a range of the early payment award amount.

A potential purchaser may use the business borrower's creditworthiness score (STEP 4) with the likelihood of a predicted, future asset to determine whether or not to exchange the predicted asset for a current payment (STEP 5). Advantageously for a purchaser who is also the buyer's customer, any current payment for a predicted, but unrealized asset likely will be at a discount to the value of an identical asset already in the borrower's books.

In some embodiments, in the event that a predicted asset does not materialize, the method and system may include the parties agreeing in advance to a set rate and a set term—similar to rates and terms associated with conventional loans—so that the purchaser may still receive the benefit of the deal at the end of the set term. In other embodiments, the borrower may structure the transaction so that the risk of an asset failing to materialize is borne primarily or entirely by the purchaser.

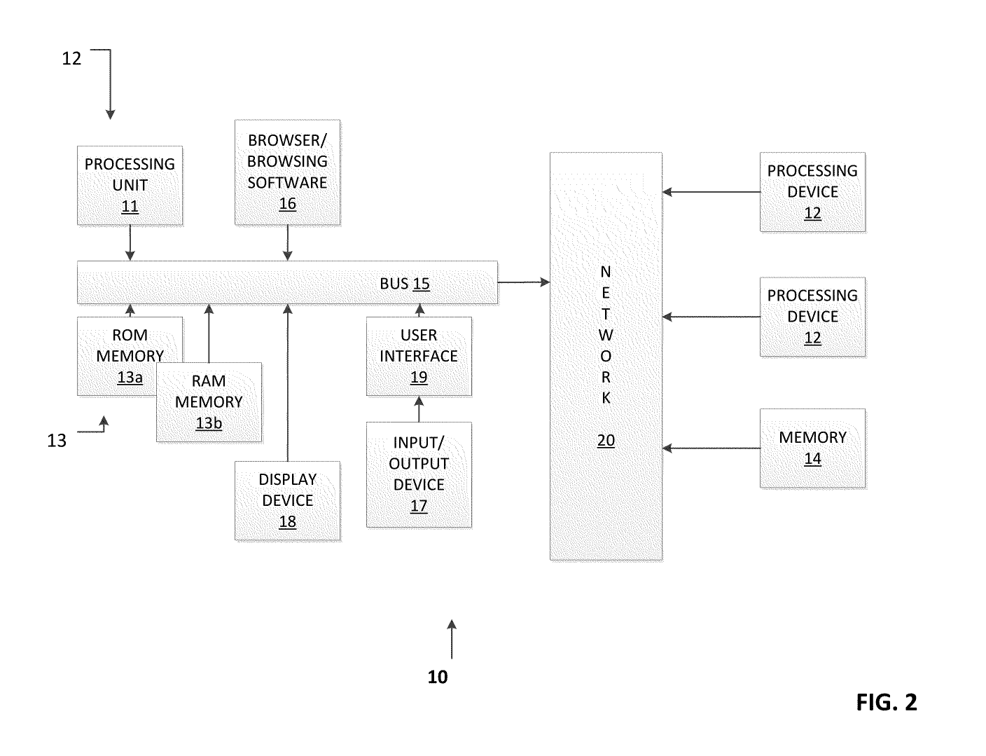

Having described an exemplary method of evaluating, e.g., scoring, a business borrower's creditworthiness, a system for executing the method will now be described. Referring to FIG. 2 and as previously mentioned, the system 10 may include a memory 14 and a processing device 12. The invention, further, may be practiced in distributed computing environments where tasks are performed by remote processing devices 12 that are linked through a communications network 20. In a distributed computing environment, program modules may be located in both local and remote computer storage media including memory storage devices 14.

In some cases, relational (or other structured) databases may provide such functionality, for example as a database management system which stores data related to the services and consumers utilizing the service. Examples of databases include the MySQL Database Server or ORACLE Database Server offered by ORACLE Corp. of Redwood Shores, Calif., the PostgreSQL Database Server by the PostgreSQL Global Development Group of Berkeley, Calif., or the DB2 Database Server offered by IBM.

The processing device 12 may include a general-purpose computing device in the form of a computer including a processing unit 11, a system memory 13, and a system bus 15 that couples various system components including the system memory 13 to the processing unit 11. The processing devices 12 typically include a variety of computer readable media that can form part of the system memory 13 and be read by the processing unit 11. By way of example, and not limitation, computer readable media may comprise computer storage media and communication media. The system memory 13 may include computer storage media in the form of nonvolatile memory such as read only memory (ROM) 13a and volatile memory such as random access memory (RAM) 13b. A basic input/output system (BIOS), containing the basic routines that help to transfer information between elements, such as during start-up, is typically stored in ROM 13a. RAM 13b typically contains data and program modules that are immediately accessible to or presently being operated on by processing unit 11. The data and program modules may include an operating system, application programs, other program modules, a browser or browsing software 16, and program data. The operating system may be or include a variety of operating systems such as Microsoft Windows® operating system, the Unix operating system, the Linux operating system, the Xenix operating system, the IBM AIX™ operating system, the Hewlett Packard UX™ operating system, the Novell Netware™ operating system, the Sun Microsystems Solaris™ operating system, the OS/2™ operating system, or another operating system of platform.

At a minimum, the system memory 13 includes at least one set of instructions that is either permanently or temporarily stored. The processing unit 11 executes the instructions that are stored in order to process data. The set of instructions may include various instructions that perform a particular task or tasks. Such a set of instructions for performing a particular task may be characterized as a program, software program, software, engine, module, component, mechanism, or tool.

The processing device 12 may include a plurality of software processing modules stored in a memory 13 as described above and executed on the processing unit 11 in the manner described herein. The program modules may be in the form of any suitable programming language, which is converted to machine language or object code to allow the processor or processors 11 to read the instructions. That is, written lines of programming code or source code, in a particular programming language, may be converted to machine language using a compiler, assembler, or interpreter. The machine language may be binary coded machine instructions specific to a particular computer.

Any suitable programming language may be used in accordance with the various embodiments of the invention. Illustratively, the programming language used may include assembly language, Ada, APL, Basic, C, C++, COBOL, dBase, Forth, FORTRAN, Java, Modula-2, Pascal, Prolog, RUM or JavaScript, for example. Further, it is not necessary that a single type of instruction or programming language be utilized in conjunction with the operation of the system and method of the invention. Rather, any number of different programming languages may be utilized as is necessary or desirable.

Also, the instructions and data used in the practice of the invention may utilize any compression or encryption technique or algorithm, as may be desired. An encryption module might be used to encrypt data. Further, files or other data may be decrypted using a suitable decryption module.

The computing environment may also include other removable or non-removable, volatile or nonvolatile computer storage media. For example, a hard disk drive may read or write to non-removable, nonvolatile magnetic media. A magnetic disk drive may read from or writes to a removable, nonvolatile magnetic disk, and an optical disk drive may read from or write to a removable, nonvolatile optical disk such as a CD-ROM or other optical media. Other removable or non-removable, volatile or nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus 15 through a removable or non-removable memory interface (not shown).

The processing unit 11 that executes commands and instructions may be a general purpose computer, but may utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID integrated circuits, smart chip, or any other device or arrangement of devices that is capable of implementing the steps of the processes of the invention.

It should be appreciated that the processing units 11 and system memories 13 of the processing devices 12 need not be physically in the same location. Each of the processing units 11 and each of the system memories 13 used by the computer system may be in geographically distinct locations and be connected so as to communicate with each other in any suitable manner. Additionally, it is appreciated that each of the processing units 11 or system memory 13 may be composed of different physical pieces of equipment.

A user may enter commands and information into the processing device 12 through a user interface 19 that includes input devices such as a keyboard and pointing device, commonly referred to as a mouse, trackball or touch pad. Other input devices 17 may include a microphone, joystick, game pad, satellite dish, scanner, voice recognition device, keyboard, touch screen, toggle switch, pushbutton, or the like. These and other input devices 17 are often connected to the processing unit 11 through a user input interface 19 that is coupled to the system bus 15, but may be connected by other interface and bus structures, such as a parallel port, game port or a universal serial bus (USB).

One or more monitors or display devices 18 may also be connected to the system bus 15 via an interface. In addition to display devices 18, processing devices 12 may also include other peripheral output devices, which may be connected through an output peripheral interface. The processing devices 12 implementing the invention may operate in a networked environment using logical connections to one or more remote processing devices, i.e., computers, the remote computers typically including many or all of the elements described above.

Various networks 20 may be implemented in accordance with embodiments of the invention, including a wired or wireless local area network (LAN) and a wide area network (WAN), wireless personal area network (PAN), and other types of networks. When used in a LAN networking environment, computers may be connected to the LAN through a network interface or adapter. When used in a WAN networking environment, processing devices 12 typically include a modem or other communication mechanism. Modems may be internal or external, and may be connected to the system bus via the user-input interface, or other appropriate mechanism. Processing devices 12 may be connected over the Internet, an Intranet, Extranet, Ethernet, or any other system or network 20 that provides communications. Some suitable communications protocols may include TCP/IP, UDP, or OSI for example. For wireless communications, communications protocols may include Bluetooth, Zigbee, IrDa or other suitable protocol. Furthermore, components of the system 10 may communicate through a combination of wired or wireless paths.

Although internal components of the processing devices 12 are not shown, those of ordinary skill in the art will appreciate that such components and the interconnections are well known. Accordingly, additional details concerning the internal construction of the computer need not be disclosed in connection with the present invention.

What we claim is:

1. A method for extending credit to a borrower, the method comprising:
estimating future receivables for the borrower; and
exchanging the estimated future receivables for a current payment.

2. The method of claim 1, wherein the payment is made by a customer of the borrower.

3. The method of claim 2, wherein the estimate is made using data concerning the historical business between the borrower and the borrower's customer.

4. The method of claim 1 further comprising the development of a creditworthiness score for the borrower based on the estimated future receivables.

5. The method of claim 1, wherein the payment discounts the amount of the estimated future receivables.

6. The method of claim 4, wherein developing a creditworthiness score includes providing a numerical score using historical business information for at least one of: the borrower's average bid, the borrower's range of bids, the borrower's average discount, the borrower's discount range, a temporal frequency of discounts, a temporal frequency of bidding, a temporal frequency of an early payment award to the borrower, an average amount of the early payment award to the borrower, and a range of the early payment award amount.

7. The method of claim 1, wherein estimating the future receivable includes at least one of:
identifying customers previously contracted with by the borrower;
identifying a frequency, amount, and total number of invoices in the aggregate for all customers previously contracted with by the borrower;
identifying a frequency, amount, and total number of invoices for a customer previously contracted with by the borrower;
evaluating industry-wide invoice loading for the borrower's industry;
evaluating industry-wide discounting, bidding, and frequency of invoices for the borrower's industry;
evaluating industry-wide invoice loading for a customer's industry; and
evaluating industry-wide discounting, bidding, and frequency of invoices for a customer's industry.

8. The method of claim 1 wherein estimating future receivables comprises estimating a likelihood of a future invoice for the borrower.

9. The method of claim 1 wherein estimating future receivables comprises estimating a value of a future predicted invoice.

10. The method of claim 1 wherein estimating future receivables comprises estimating a temporal range for a future predicted invoice.

11. A method of predicting and scoring a probability of a projected, future asset:
estimating future receivables for a borrower; and
developing a creditworthiness score for the borrower based on the estimated future receivables, wherein
the creditworthiness score includes providing a numerical score using historical business information for at least one of: the borrower's average bid, the borrower's range of bids, the borrower's average discount, the borrower's discount range, a temporal frequency of discounts, a temporal frequency of bidding, a temporal frequency of an early payment award to the borrower, an average amount of the early payment award to the borrower, and a range of the early payment award amount.

12. A system for extending credit to a borrower, wherein the credit is provided by the at least one customer, the system comprising:
a memory containing borrower's historical business data; and
a processing device that is structured and arranged to process the historical business data from the memory and to estimate a future receivable for any of a plurality of customers, wherein the estimate of the future receivable is stored in a suitable database in the memory.

13. The system of claim 12 wherein the historical business data includes historical business transactions between the borrower and any of the plurality of customers.

14. The system of claim 13 wherein the estimate is made using the historical business transaction data.

15. The system of claim 12 wherein the processing devices is structured and arranged to develop a creditworthiness score for the borrower based on the estimated future receivables, wherein the creditworthiness score is stored in a suitable database in the memory.

16. The system of claim 12 wherein the processing device is adapted to estimate the future receivable using at least one of:
identifying customers previously contracted with by the borrower;
identifying a frequency, amount, and total number of invoices in the aggregate for all customers previously contracted with by the borrower;
identifying a frequency, amount, and total number of invoices for a customer previously contracted with by the borrower;
evaluating industry-wide invoice loading for the borrower's industry;
evaluating industry-wide discounting, bidding, and frequency of invoices for the borrower's industry;
evaluating industry-wide invoice loading for a customer's industry; and
evaluating industry-wide discounting, bidding, and frequency of invoices for a customer's industry.

17. The system of claim 12 wherein the processing device is adapted to estimate a likelihood of a future invoice for the borrower.

18. The system of claim 12 wherein the processing device is adapted to estimate a value of a future predicted invoice in estimating future receivables.

19. The system of claim 12 wherein the processing device is adapted to estimate a temporal range for a future predicted invoice in estimating future receivables.

20. The system of claim 12 wherein the processing device is adapted to exchange the estimated future receivable for a payment.
